(19) United States
(12) Patent Application Publication
(10) Pub. No.: US 2024/0357454 A1
(43) Pub. Date: Oct. 24, 2024

(54) METHOD, APPARATUS AND USER EQUIPMENT FOR CELL-CHANGE ASSISTANCE IN NON-TERRESTRIAL NETWORKS

(71) Applicant: Nokia Technologies Oy, Espoo (FI)

(72) Inventors: Sandra HOPPE, Munich (DE); Mads LAURIDSEN, Aalborg (DK); István Zsolt KOVÁCS, Aalborg (DK); Hans Thomas HÖHNE, Espoo (FI); Jedrzej STANCZAK, Wroclaw (PL)

(21) Appl. No.: 18/684,875

(22) PCT Filed: Aug. 25, 2021
(86) PCT No.: PCT/EP2021/073488

§ 371 Date: Feb. 20, 2024

(51) Int. Cl. H04W 36/08; H04W 36/32; H04W 84/06

(52) U.S. Cl. CPC H04W 36/083; H04W 36/32; H04W 84/06

(57) ABSTRACT

A method, apparatus and computer program product are provided for cell change assistance in a non-terrestrial network. NTN, with a plurality of moving cells served by at least one satellite. A network element of the NTN provides cell change assistance information to a user equipment, UE, for selecting at least one moving cell of the plurality of moving cells. The UE receives cell change assistance information for selecting a cell for cell change. The cell change assistance information identifies at least a subset of the plurality of moving cells and us indicative of a geometric layout of at least the subset of the plurality of moving cells. The UE selects at least one moving cell from the plurality of moving cells as target cell for cell change, based on the received cell change assistance information

### FIELD

This disclosure generally relates to mobile communication networks such as a 5G communication network, and more particularly to cell change in non-terrestrial networks.

### BACKGROUND

The fifth-generation technology standard for broadband cellular networks (5G) targets a variety of use cases and industries. A more distributed core with combination of variety of radio access networks (RAN) deployments are generally viewed as the framework for more flexibility, customization, and service-driven management in a viable 5G system. In this context, 3GPP Technical Report 38.821 specifies solutions for New Radio (NR) to also support non-terrestrial networks (NTN).

NTN refers to any networks which use an airborne or spaceborne platform as a part of the network, such as satellites, high-altitude platforms or drones. An example of such NTN in the context of 5G NR-RAN may employ multiple satellites, each satellite functioning as a network element, in particular functioning as a gNodeB (e.g., a gNodeB distributed unit, gNB-DU on board of the satellite). The NTN may further comprise on-earth components, such as an NTN gateway, which links the on-board gNB-DU with one or more on-earth gNodeB central units, gNB-CU. In the following, the term network element shall be understood as encom-passing on-board network elements and on-earth network elements.

For instance, satellites can be classified in terms of their movement relative to the Earth surface. Geostationary Earth Orbit (GEO) satellites are deployed at an altitude where they maintain their position relative to the Earth surface. At lower altitudes, Low-Earth Orbit (LEO) satellites are deployed in large constellations and move with respect to the Earth's surface (e.g., with a speed of approximately 7.5 km/s) to maintain their orbit. In comparison to GEO satellites, the advantage of LEO satellites is global and high-speed communication with a low delay due to the lower round-trip time (RTT).

One of the basic deployment options for the cells broadcasted by non-geostationary satellites (e.g., LEO satellites) are Earth-moving cells (also referred to as moving cells), which are characterized by cells' coverage being below the satellite and thus by moving with respect to the Earth's surface essentially according to the satellite's orbital trajectory. However, the movement of LEO satellites with respect to the Earth is at the same time one of the main challenges for LEO communications. For instance, it may lead to very frequent cell changes (e.g., handovers), even if the user equipment (UE) is not moving.

Thus, there is a need for NTN mobility mechanisms, such as conventional radio-based measurement event triggering and reporting by UE after which the network decides whether the UE shall handover or not. A further option includes conditional handover (CHO), where the UE is preconfigured with target cells, which it can handover to, when configured radio conditions are suitable. Moreover, NTN-specific enhancements are conceivable where UE location and predictable satellite movement is taken into account to develop additional triggers relying on cell availability time, timers and/or distance to satellite/cell.

At any given time, multiple suitable cells might be available for mobility, although any unnecessary cell change should be avoided.

Therefore, there is a need for methods, apparatus and computer program products, which address the problem mentioned above, such as reducing the number of mobility events.

### SUMMARY

In the present disclosure, methods, apparatus, systems and computer programs for assisting or preparing cell change in non-terrestrial networks are presented.

According to a first aspect, a method for cell change assistance in a non-terrestrial network, NTN, is provided. The NTN has a plurality of moving cells served by at least one satellite. The method comprises providing, by a network element of the NTN to a user equipment, UE, cell change assistance information for selecting at least one moving cell of the plurality of moving cells. The cell change assistance information identifies at least a subset of the plurality of moving cells and is indicative of a geometric layout of at least the subset of the plurality of moving cells.

In embodiments, the method may further comprise generating, by the network element or by another entity, the cell change assistance information. For instance, the cell change assistance information provided by the network element may be generated by an NTN infrastructure element (in particular an NTN control function element), and be provided to the network element.

In particular, the generating may be based on information indicative of one or more of the following: a serving cell for the UE; a position of the UE; a movement of the UE; a movement of the satellite.

In a second aspect, a method for preparing cell change of a user equipment, UE, in a non-terrestrial network, NTN, is provided. The NTN has a plurality of moving cells served by at least one satellite. The method comprises receiving cell change assistance information by the UE and selecting at least one moving cell as target cell for cell change.

The received cell change assistance information is provided by a network element of the NTN and is for selecting a cell for cell change. It identifies at least a subset of the plurality of moving cells and is indicative of a geometric layout of at least the subset of the plurality of moving cells. The selecting of at least one moving cell from the plurality of moving cells as target cell for cell change is based on the received cell change assistance information.

In some embodiments, the method further comprises: updating a database of cell information, the database comprising previously received cell change assistance information, with the presently received cell change assistance information for use after selecting the cell.

In such cases, the selecting of a target cell may further be based on the stored database of previously received cell change assistance information and/or presently received cell change assistance information.

In some embodiments, the selecting of a target cell may further be based on information indicative of one or more of the following: a position of the UE; a movement of the UE; a movement of the satellite; a location of the cell; a movement of the cell; a received power of the cell at the UE; an expected availability time of the cell coverage at the UE position.

In some embodiments, the method may further comprise: performing cell change, in response to one or more of the following: one or more radio-based measurement events; one or more conditional handover, CHO, conditions; one or more NTN trigger events.

Examples of NTN trigger events include cell availability time; timers; distance to satellite; distance to cell center.

In some embodiments, the cell change assistance information may further be indicative of the movement of the plurality of cells. In some examples, the cell change assistance information may comprise an indication of the direction and velocity. For instance, such indication may be encoded as a vector, with the direction of the vector being indicative of the direction of cell movement and the magnitude of the vector being indicative of the velocity of cell movement. In other examples, the movement of the plurality of cells may be indicated by virtue of satellite ephemeris information.

In some embodiments, the subset of moving cells indicated by the cell change assistance information may constitute less than a full footprint of cells served by the satellite. For instance, merely a partial footprint, such as a layout in the vicinity of the active cell may be indicated. More particularly, the partial footprint may be pre-determined based on the full layout and the direction of cell/satellite movement. For instance, a partial layout in the shape of a tail in direction of satellite movement may be indicated.

In some embodiments, the cell change assistance information may be indicative of one of a plurality of pre-defined footprint layouts.

For instance, each of the plurality of pre-defined footprint layouts may be characterized by a geometric cell pattern. Geometric cell patterns may include rectangular patterns, circular patterns, hexagonal patterns, etc.

In cases where the cell change assistance information indicates a pre-defined footprint layout, the cell change assistance information may further be indicative of a numbering of cell identifiers within the indicated one of the plurality of pre-defined footprint layouts. In particular, the numbering of cell identifiers within the footprint layout may define one cell identifier for each cell in the layout. This may occur explicitly, e.g., by stating one identifier for each cell. Alternatively, this may occur implicitly, e.g., by virtue of a numbering scheme. For instance, a numbering scheme may indicate a starting cell (i.e., a starting position within the layout) along with a starting identifier (i.e., the identifier of the starting cell). The remaining cells may then be numbered incrementally. If needed, the scheme may also indicate a numbering sequence, i.e., in which sequence the remaining cells are to be numbered.

For instance, the cell identifiers may comprise one or more of the following: a physi-cal cell identifier, PCI; a global cell identifier, GCID; a cell global identity, CGI; a base station identifier. For example, the NR Cell Global Identifier (NCGI) of 5G-NR may be used, which is to identify NR cells globally. The NCGI is constructed from the PLMN identity the cell belongs to and the NR Cell Identity (NCI) of the cell. An example of a base station identifier is the gNB Identifier (gNB ID) of 5G-NR, which may be used to identify gNBs within a PLMN. The gNB ID is contained within the NCI of its cells. Another example includes the Global gNB ID, which may be used to identify gNBs globally. The Global gNB ID is constructed from the PLMN identity the gNB belongs to and the gNB ID.

In some embodiments, the cell change assistance information may be provided via a dedicated channel or via a broadcast channel. For instance, in the case of a broadcast channel, this allows to distribute the same assistance information to all UE within the cell. Alternatively, in the case of a dedicated channel, the distribution may be individualized to the needs and circumstances of the particular UE.

In some embodiments, the geometric layout may be indicative, for each of the plurality of cells, of one or more of the following: a cell shape; one or more cell center locations; one or more cell radii. For instance, a circular cell may be characterized by a radius and one set of center coordinates (e.g., longitude/latitude). Similarly, an elliptical cell may be characterized by two radii (e.g., major axis radius and minor axis radius) and two sets of center (or focus) coordinates (e.g., longitude/latitude). In a simpler example, an elliptical cell may also be characterized by two radii and one set of center coordinates. Other, more complex shapes may be characterized by corresponding parameters.

In a third aspect, a radio access network element is provided for cell change assistance in a non-terrestrial network, NTN, with a plurality of moving cells served by at least one satellite. The network element is configured to carry out the steps of a method according to the first aspect. It is configured to provide cell change assistance information to a user equipment, UE, for selecting at least one moving cell of the plurality of moving cells. The cell change assistance information identifies at least a subset of the plurality of moving cells and is indicative of a geometric layout of at least the subset of the plurality of moving cells. In particular, the network element according to the third aspect may perform the steps of any method according to the first aspect.

In some embodiments, the network element provided in the third aspect may be a gNodeB (in particular a gNodeB central unit or a gNodeB distributed unit). In some instances, the network element may be located on board of the at least one satellite, which serves the plurality of moving cells. In other instances, the network element may be located on-earth and may be linked to the at least one satellite via at least an NTN gateway. In any case, the cell change assistance information provided by the network element may be transmitted to user equipment via the at least one satellite. In some instances, the cell change assistance information provided by the network element may originate from other entities, such as an NTN infrastructure element (in particular an NTN control function element), and be provided by these other entities to the network element.

In a fourth aspect, a user equipment, UE, is provided, which is configured for preparing cell change in a non-terrestrial network, NTN, with a plurality of moving cells served by at least one satellite. The UE is configured to carry out the steps of a method according to the second aspect. It is configured to receive cell change assistance information provided by a network element of the NTN for selecting a cell for cell change. The cell change assistance information identifies at least a subset of the plurality of moving cells and is indicative of a geometric layout of at least the subset of the plurality of moving cells. The UE is also configured to select at least one moving cell from the plurality of moving cells as target cell for cell change, based on the received cell change assistance information. In particular, the UE according to the fourth aspect may perform the steps of any method according to the second aspect.

In a fifth aspect, a computer program is provided, comprising computer program code which, when executed by a computer, causes at least one computer to perform the method of the first or second aspect.

Additionally or alternatively, the computer program product comprises program instructions stored on a computer readable medium to execute the method according to the first or second aspect when said program is executed on a computer.

According to a sixth aspect, a wireless communication system is provided, comprising a network element according to the third aspect and a user equipment, UE, according to the fourth aspect.

### BRIEF DESCRIPTION OF THE FIGURES

A better understanding of the subject matter described herein can be obtained when the following detailed description of various embodiments is considered in conjunction with the following drawings, in which:

FIG. 1 illustrates a simplified wireless communication system, according to some embodiments.

FIG. 2 illustrates a base station (BS) in communication with a user equipment (UE) according to some embodiments.

FIG. 3 illustrates a simplified block diagram of a UE according to some embodiments.

FIG. 4 illustrates a simplified block diagram of a network node according to some embodiments.

FIG. 5 illustrates a plurality of moving cells of a non-terrestrial network (NTN) according to some embodiments.

FIG. 6 illustrates a flow chart of a method performed by a network element according to some embodiments.

FIG. 7 illustrates a flow chart of a method performed by a user equipment according to some embodiments.

FIG. 8 illustrates multiple footprint layouts according to some embodiments.

FIG. 9 illustrates a communication between a user equipment and a network element according to some embodiments.

### DETAILED DESCRIPTION

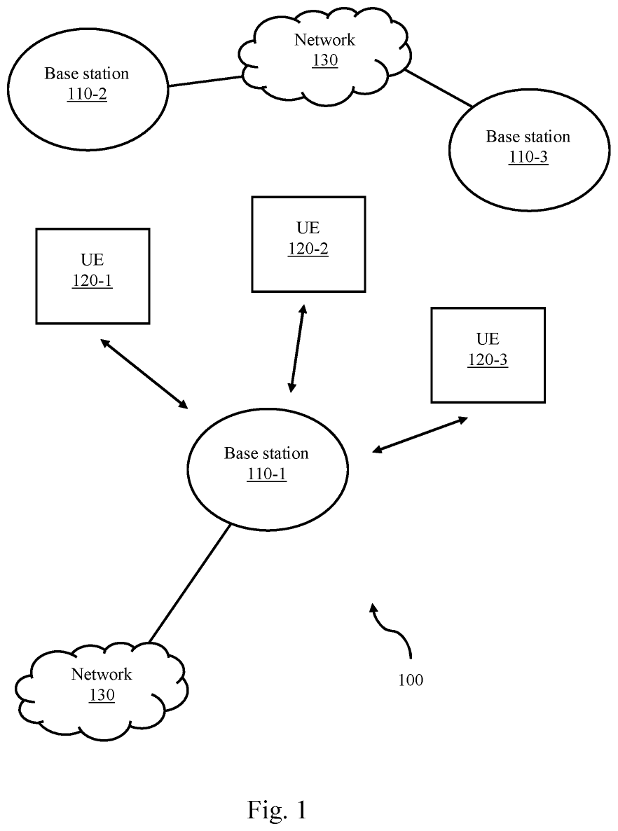

FIG. 1 illustrates a simplified wireless communication system 100, according to some embodiments. It is noted that the system of FIG. 1 is merely one example of a possible system, and that features of the subject matter described herein may be implemented in any of various systems, as desired.

As shown, the wireless communication system 100 includes a base station 110-1 which communicates over a transmission medium with one or more user devices 120. In FIG. 1, three user devices 120-1, 120-2, and 120-3 are shown in communication with one base station 110-1, without limitation. Each of the user devices 120-1, 120-2, and 120-3 may be referred to herein as a “user equipment” (UE). Thus, the user devices 120 are referred to as UEs or UE devices.

As used herein, the term “user equipment” may refer to any of various types of com-puter systems devices which are mobile or portable and which perform wireless communications. Examples of UEs include mobile telephones or smart phones, portable gaming devices, laptops, wearable devices (e.g., smart watch, smart glasses), Personal Digital Assistants (PDAs), portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

The base station (BS) 110-1 may be a base transceiver station (BTS) or cell site (a “cellular base station”), and may include hardware that enables wireless communication with the UEs 120. In particular, it may be an airborne or spaceborne station, such as a satellite.

As used herein, the term “base station” has the full breadth of its ordinary meaning, and at least includes a wireless communication station (whether it be installed at a fixed location or at an airborne or spaceborne station) and used to communicate as part of a wireless telephone system or radio system. Considering the example of FIG. 1, base station 110-1 can be a stationary station, whereas base stations 110-2 and 110-3 can be moving satellite base stations.

The communication area (or coverage area) of the base station 110 may be referred to as a “cell.” The base station 110 and the UEs 120 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. If the base station 110-1 is implemented in the context of LTE, it may alternately be referred to as an “eNodeB” or “eNB”. If the base station 110-1 is implemented in the context of 5G NR, it may alternately be referred to as “gNodeB” or “gNB”. Without limitation, any cell served by each of the base station may be stationary (e.g., the cell served by stationary base station 110-1) or moving relative to the Earth (e.g., the cells served by moving base stations 110-2 or 110-3). The (sub-) network comprising base stations 110-2 and 110-3 may be referred to as a non-terrestrial network.

As shown, the base station 110-1 may also be equipped to communicate with a network 130 (e.g., a core network of a cellular service provider, a telecommunication network such as a public switched telephone network (PSTN), and/or the Internet, among various pos-sibilities). Thus, the base station 110-1 may facilitate communication between the user devices 120 and/or between the user devices 120 and the network 130. In particular, the cellular base station 110-1 may provide UEs 120 with various telecommunication capabilities, such as voice, SMS and/or data services.

The base station 110-1 and other similar base stations (such as base stations 110-2 and 110-3) operating according to the same or a different cellular communication standard may thus be provided as a network of cells, which may provide continuous or nearly continuous overlapping service to UEs 120 and similar devices over a geographic area via one or more cellular communication standards.

Thus, while base station 110-1 may act as a “serving cell” for UEs 120 as illustrated in FIG. 1, each UE 120 may also be capable of receiving signals from (and possibly within communication range of) one or more other cells (which might be provided by base stations 110 and/or any other base stations), which may be referred to as “neighboring cells”. Such cells may also be capable of facilitating communication between user devices 120 and/or between user devices 120 and the network 130. Such cells may include “macro” cells, “micro” cells, “pico” cells, and/or cells which provide any of various other granularities of service area size. For example, base stations 110-2 and 110-3 illustrated in FIG. 1 might be macro cells, while base station 110-1 might be a micro cell. Other configurations are also possible.

In some embodiments, base station 110 may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

The UE 120 may be capable of communicating using multiple wireless communication standards. For example, the UE 120 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 120 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

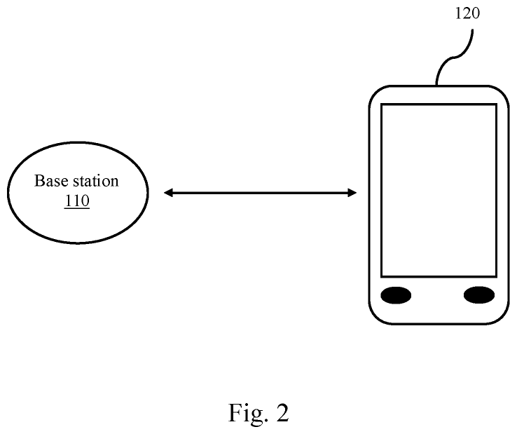

FIG. 2 illustrates user equipment 120 (e.g., one of the devices 120-1, 120-2 and 120-3) in communication with a base station 110, according to some embodiments. The UE 120 may be a device with cellular communication capability such as a mobile phone, a handheld device, a computer or a tablet, or virtually any type of wireless device.

The UE 120 may include a processor that is configured to execute program instructions stored in memory. The UE 120 may perform any of the method embodiments described herein by executing such stored instructions. Alternatively, or in addition, the UE 120 may include a programmable hardware element such as an field-programmable gate array (FPGA) that is configured to perform any of the method embodiments described herein, or any portion of any of the method embodiments described herein.

The UE 120 may include one or more antennas for communicating using one or more wireless communication protocols or technologies. In some embodiments, the UE 120 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 120 may share one or more parts of a receive and/or transmit chain between multiple wireless communication technologies, such as those discussed above.

In some embodiments, the UE 120 may include separate transmit and/or receive chains (e.g., including separate antennas and other radio components) for each wireless communication protocol with which it is configured to communicate. As a further possibility, the UE 120 may include one or more radios which are shared between multiple wireless communication protocols, and one or more radios which are used exclusively by a single wireless communication protocol. For example, the UE 120 might include a shared radio for communicating using either of LTE or 5G NR (or LTE or 1×RTT or LTE or GSM), and separate radios for communicating using each of Wi-Fi and Bluetooth. Other configurations are also possible.

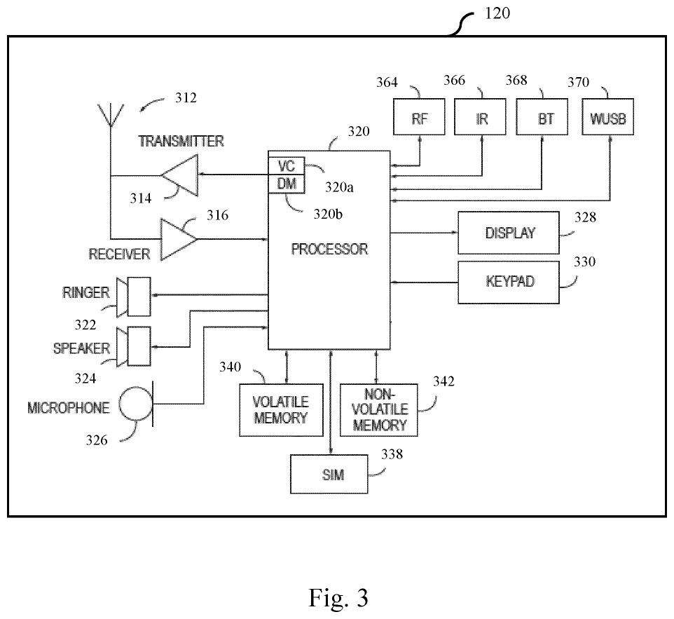

FIG. 3 illustrates a simplified block diagram of a UE 120, according to some embodiments. It is noted that the block diagram of the UE 120 of FIG. 3 is only one example of a possible user device. According to embodiments, UE 120 may be a user device, a mobile device or mobile station, a wireless device or wireless station, a desktop computer or computing device, a mobile computing device (e.g., a laptop, notebook, or portable computing device), a tablet and/or a combination of devices, among other devices.

As shown, the UE 120 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indi-rectly) to various other circuits of the UE 120.

The UE 120 may include at least one antenna 312 in communication with a transmitter 314 and a receiver 316. Alternatively, transmit and receive antennas may be separate. The UE 120 may also include a processor 320 configured to provide signals to and receive signals from the transmitter 314 and receiver 316, respectively, and to control the functioning of the UE 120. Processor 320 may be configured to control the functioning of the transmitter 314 and receiver 316 by effecting control signaling via electrical leads to the transmitter 314 and receiver 316. Likewise, the processor 320 may be configured to control other elements of the UE 120 by effecting control signaling via electrical leads connecting processor 320 to the other elements, such as a display or a memory. The processor 320 may, for example, be embodied in a variety of ways including circuitry, at least one processing core, one or more mi-croprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 3 as a single processor, in some example embodiments the processor 320 may comprise a plurality of processors or processing cores.

The UE 120 may be capable of operating with one or more air interface standards, communication protocols, modulation types, access types, and/or the like. Signals sent and received by the processor 320 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the UE 120 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the UE 120 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the UE 120 may be capable of operating in accordance with 2.5G wireless communication protocols General Packet Radio Service (GPRS), Enhanced Data GSM Environment (EDGE), and/or the like. Further, for example, the UE 120 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The UE 120 may be additionally capable of operating in accordance with 3.9G wireless communication protocols, such as Long Term Evolution (LTE), Evolved Universal Terrestrial Radio Access Network (E-UTRAN), and/or the like. Additionally, for example, the UE 120 may be capable of operating in accordance with 4G wireless communication protocols, such as LTE Advanced, 5G, and/or the like as well as similar wireless communication protocols that may be subsequently developed.

It is understood that the processor 320 may include circuitry for implementing au-dio/video and logic functions of the UE 120. For example, the processor 320 may comprise a digital signal processor device, a microprocessor device, an analog-to-digital converter, a dig-ital-to-analog converter, and/or the like. Control and signal processing functions of the UE 120 may be allocated between these devices according to their respective capabilities. The processor 320 may additionally comprise an internal voice coder (VC) 320a, an internal data modem (DM) 320b, and/or the like. Further, the processor 320 may include functionality to operate one or more software programs, which may be stored in memory. In general, the processor 320 and stored software instructions may be configured to cause the UE 120 to perform actions. For example, the processor 320 may be capable of operating a connectivity program, such as a web browser. The connectivity program may allow the UE 120 to transmit and receive web content, such as location-based content, according to a protocol, such as wireless application protocol (WAP), hypertext transfer protocol (HTTP), and/or the like.

The UE 120 may also comprise a user interface including, for example, an earphone or speaker 324, a ringer 322, a microphone 326, a display 328, a user input interface, and/or the like, which may be operationally coupled to the processor 320. The display 328 may, as noted above, include a touch sensitive display, where a user may touch and/or gesture to make se-lections, enter values, and/or the like. The processor 320 may also include user interface circuitry configured to control at least some functions of one or more elements of the user interface, such as the speaker 324, the ringer 322, the microphone 326, the display 328, and/or the like. The processor 320 and/or user interface circuitry comprising the processor 320 may be configured to control one or more functions of one or more elements of the user interface through computer program instructions, for example, software and/or firmware, stored on a memory accessible to the processor 320, for example, volatile memory 340, non-volatile memory 342, and/or the like. The UE 120 may include a battery for powering various circuits related to the mobile terminal, for example, a circuit to provide mechanical vibration as a de-tectable output. The user input interface may comprise devices allowing the UE 120 to receive data, such as a keypad 330 (which can be a virtual keyboard presented on display 328 or an externally coupled keyboard) and/or other input devices.

As shown in FIG. 3, the UE 120 may also include one or more mechanisms for sharing and/or obtaining data. For example, UE 120 may include a short-range radio frequency (RF) transceiver and/or interrogator 364, so data may be shared with and/or obtained from electronic devices in accordance with RF techniques. The UE 120 may include other short-range transceivers, such as an infrared (IR) transceiver 366, a Bluetooth (BT) transceiver 368 operating using Bluetooth wireless technology, a wireless universal serial bus (USB) transceiver 370, a Bluetooth Low Energy transceiver, a ZigBee transceiver, an ANT transceiver, a cellular device-to-device transceiver, a wireless local area link transceiver, and/or any other short-range radio technology. The UE 120 and, in particular, the short-range transceiver may be capable of transmitting data to and/or receiving data from electronic devices within the proxim-ity of the UE, such as within 10 meters, for example. The UE 120 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The UE 120 may comprise memory, such as a subscriber identity module (SIM) 338, a removable user identity module (R-UIM), an eUICC, an UICC, and/or the like, which may store information elements related to a mobile subscriber. In addition to the SIM, the UE 120 may include other removable and/or fixed memory. The UE 120 may include volatile memory 340 and/or non-volatile memory 342. For example, the volatile memory 340 may include Random Access Memory (RAM) including dynamic and/or static RAM, on-chip or off-chip cache memory, and/or the like. The non-volatile memory 342, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory 340, the non-volatile memory 342 may include a cache area for temporary storage of data. At least part of the volatile and/or non-volatile memory may be embedded in the processor 320. The memories may store one or more software programs, instructions, pieces of information, data, and/or the like which may be used by the UE for performing operations disclosed herein.

The memories may comprise an identifier, such as an International Mobile Equipment Identification (IMEI) code, capable of uniquely identifying the UE 120. The memories may comprise an identifier, such as an international mobile equipment identification (IMEI) code, capable of uniquely identifying the UE 120. In the example embodiment, the processor 320 may be configured using computer code stored at memory 340 and/or 342 to cause the processor 320 to perform operations disclosed herein.

Some of the embodiments disclosed herein may be implemented in software, hardware, application logic, or a combination of software, hardware, and application logic. The software, application logic, and/or hardware may reside on the memory 340, the processor 320, or electronic components, for example. In some example embodiment, the application logic, software or an instruction set is maintained on any one of various conventional com-puter-readable media. In the context of this document, a “computer-readable medium” may be any non-transitory media that can contain, store, communicate, propagate or transport the instructions for use by or in connection with an instruction execution system, UE, or device, such as a computer or data processor circuitry, with examples depicted at FIG. 3, computer-readable medium may comprise a non-transitory computer-readable storage medium that may be any media that can contain or store the instructions for use by or in connection with an instruction execution system, UE, or device, such as a computer.

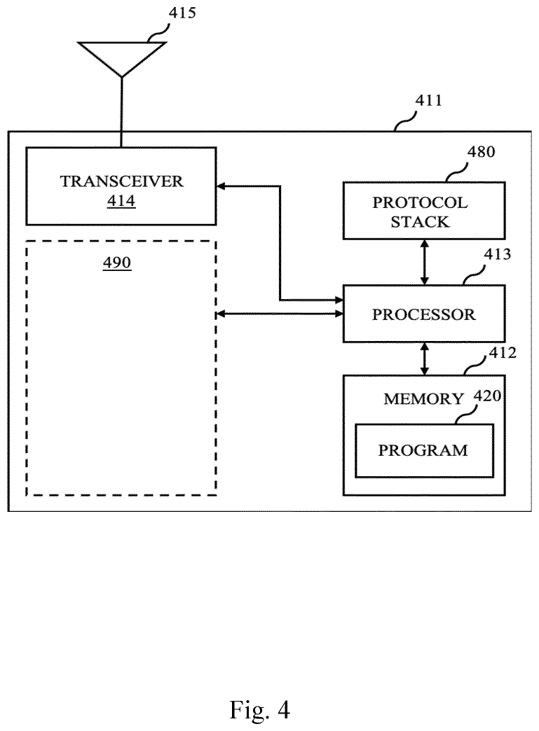

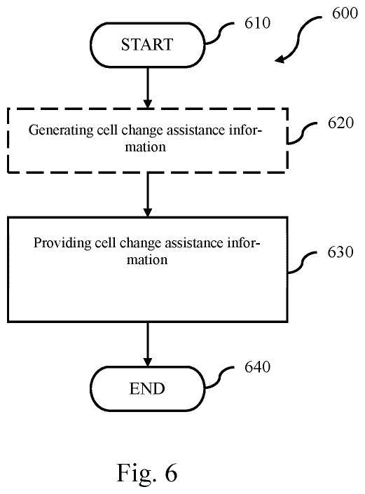

FIG. 4 illustrates a simplified block diagram of a network node 411 in accordance with some embodiments. Network node 411 may be a base station combined with an MME or AMF. Network node 411 has an antenna 415, which transmits and receives radio signals. A radio frequency (RF) transceiver module 414, coupled with the antenna, receives RF signals from antenna 415, converts them to baseband signals and sends them to processor 413. RF transceiver 414 also converts received baseband signals from processor 413, converts them to RF signals, and sends out to antenna 415. Processor 413 processes the received baseband signals and invokes different functional modules to perform features in network node 411. Memory 412 stores program instructions and data 420 to control the operations of the network node 411. In the example of FIG. 6, network node 411 also includes protocol stack 480 and a set of control functional modules and circuit 490 implementing the mobility management functionality described above. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines. Other nodes of the communication network such as the servers of the EDNs are equipped accordingly, i.e. with similar internal components. Instead of RF transceiver module 414 and antenna 415, these nodes may be em-ployed wired communication technologies in order to communicate with the other network nodes.

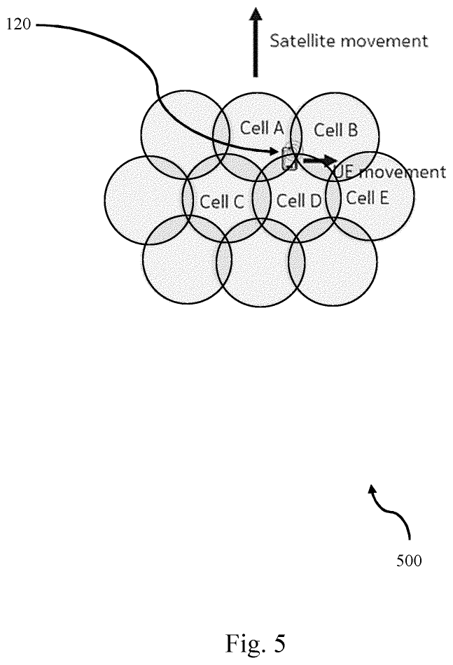

FIG. 5 illustrates a plurality 500 of earth-moving cells (in the following: moving cells) of a non-terrestrial network (NTN) at a given point in time. In the illustrated example, the plurality of cells moves in conjunction, due to the movement by the serving satellite. In other examples, the plurality of moving cells may comprise a first group of cells, moving in a first direction, and at least a second group of cells, moving in (at least) one other direction. Such examples may arise in situations where the first group of cells is served by a first satellite and the second group of cells is served by a second satellite with a different orbit.

Returning to the example of FIG. 5, for ease of illustration and without limitation, the satellite movement is indicated in south-north direction. Other satellites may move in other directions.

Moreover, FIG. 5 illustrates a UE 120 served by the network of the plurality 500 of cells. The UE is illustrated as moving in west-east direction, for sake of illustration. In other examples, not illustrated, the UE may be (essentially) stationary with respect to the surface of the Earth. At the illustrated point in time, UE may be connected to cell A. The connection of the UE to cell A (RRC_IDLE, RRC_INACTIVE) may include mere camping on the cell A or a current packet-switched connection (RRC_CONNECTED).

At any given time, multiple suitable cells might be available for triggering a measurement report (if conventional mobility mechanism is used) or triggering a handover execution (if CHO is used). Considering the satellite movement, some cells are likely to disappear soon, such that choosing these cells would likely result in a further handover in a short time instant. This would be detrimental to the performance. Given that some Earth-moving cells might be visible for only approximately 10 seconds (which is the case for a LEO satellite at 600 km altitude with a 50 km cell radius) depending on the cell size, any unnecessary cell change shall be avoided.

Thus, due to the movement of the satellite (and of the UE), this cell A will soon be no longer available to the UE. However, other cells (such as cells D or B) will likely be available for cell change (reselection or handover). Although cell B may be within reach for cell change, the rapid satellite movement will make cell B a non-preferred target cell as it will soon “disappear” from the perspective of the UE. If the UE were to initiate or perform a cell change to cell B, the UE will likely have to initiate and perform another cell change soon thereafter, in view of the satellite movement. Instead, cell D may be a preferrable target cell, since it will be available for a longer duration, thereby reducing the number of mobility events (and thus improve performance) despite the rapid satellite movement. A mere list of identifiers of neighboring cells is not sufficient to perform such intelligent selection. The methods, apparatus and computer program products of the present disclosure allow to select a suitable for cell change taking into account the layout of the plurality of cells and thereby reducing the number of mobility events in order to improve performance.

FIG. 6 illustrates a flow chart of a method 600, as performed by a network element, such as base station 110, whether it be an on-board (i.e., space-borne or air-borne) base station or an on-earth base station.

The method is for cell change assistance in a non-terrestrial network, NTN with a plurality of moving cells served by at least one satellite.

The method 600 comprises an (optional) step 620 of generating, by the network element, cell change assistance information. The cell change assistance information identifies at least a subset of the plurality of moving cells and is indicative of a geometric layout of at least the subset of the plurality of moving cells.

In the step 620 of method 600, the generated cell change assistance information indicates less than a full footprint of cells served by the satellite, i.e., merely a partial footprint. Considering the example layout of FIG. 5, the set of cells A, B, C, D, E constitutes less than the full footprint (which full footprint additionally comprises the five cells which are illustrated without identifier).

Generating cell change assistance information for merely a partial footprint allows to signal, for instance, only those cells, which are in vicinity of the active cell (and thus are or will be in vicinity of the UE). Considering the example of FIG. 5, at least cells B, C and D could be considered as being in vicinity of serving cell A, whereas cell E could be considered as not being in vicinity of serving cell A. Thus, the generating may be based on information indicative of the serving cell.

Alternatively, or additionally, the generating may be based on satellite movement. In particular, the partial footprint may be pre-determined based on the full layout and the direction of cell/satellite movement. For instance, a partial layout in the shape of a tail in direction of satellite movement may be indicated. Considering the example layout of FIG. 5, cells C or D may be considered tailing cell A. As a result, the cell change assistance information for UE 120 in cell A shall comprise a layout comprising at least cells C and D. Conversely, cell A is leading (i.e., not tailing) cells C or D. As a result, cell change assistance information for (another) UE in cell C or D shall comprise a layout, which may not need to indicate cell A.

This generating of cell change assistance information for merely a partial footprint allows to reduce the signaling overhead (e.g., in the case of conventional handover) or to reduce the number of handovers (e.g., in the case of conditional handovers, CHO).

Alternatively, or additionally, the generating may be based on UE position and/or UE movement. For instance, considering the example of FIG. 5, the illustrated UE 120 is located nearer to (the center of) cell D than to (the center of) cell C. Moreover, the illustrated UE 120 is moving towards cell D and away from cell C. Thus, both the UE position and the UE movement (together with information on satellite or cell movement in this example) provide a basis for including the information for cell D in the cell change assistance information, whereas cell C may be omitted or at least de-prioritized.

The method 600 comprises a step 630 of providing, by a network element of the NTN to a user equipment, UE, the generated cell change assistance information for selecting at least one moving cell of the plurality of moving cells. For instance, the generated cell change assistance information may be provided by virtue of a message encoding the contents and structure of Table 1 below.

TABLE 1
exemplary cell change assistance information

| Index | Cell identifier | Geometry | Parameters for geometry |
|---|---|---|---|
| A | PCI1 | Circular | Coordinates1, Radius1 |
| B | PCI2 | Circular | Coordinates2, Radius2 |
| C | PCI3 | Circular | Coordinates3, Radius3 |
| D | PCI4 | Circular | Coordinates4, Radius4 |
| E | PCI5 | Elliptical | Coordinates5a, Radius5a |
| | | | Coordinates5b, Radius5b |

For instance, the cell change assistance information may be broadcast via a broadcast channel, which allows to distribute the same assistance information to all UE within the cell. Broadcast information may be signaled implicitly by virtue of being linked to the overall mobile network operation configuration or it may be signaled explicitly, e.g. as being specific to the particular access network and/or to the particular satellite.

Alternatively, the cell change assistance information may be provided via a dedicated channel. Thereby, the distribution may be individualized to the needs and circumstances of the particular UE, such as in the case of cell change assistance information individualized on the basis of UE location and/or UE movement.

In the example above, the cell change assistance information comprises indications of the cell center location and the cell radius for each cell. In other examples, each cell may be characterized by other information, such as a cell score, for instance.

Examples of such cell score may be indicative of the duration of a minimum radio coverage signal strength level at a certain location, starting at a certain time. For instance, a score1 (T2) would mean that a first time-of-stay (ToS1) is achieved starting at time T2. The signaling of such score measure would allow to not disclose the spatial details of the cell patterns. Furthermore, the score can be based on or indicative of further parameters such as for instance load, or cell offsets, thereby giving the network more freedom to steer the UEs and thereby optimize load, for instance.

The signaling of cell geometries and of cell scores can also be combined such that the UE may use the cell geometry information to estimate when a cell of the satellite beam pattern will likely come into view, while the network additionally provides a score that may be indicative of cell load and/or interference levels, for instance. Such combination would allow to avoid sending location-based scores.

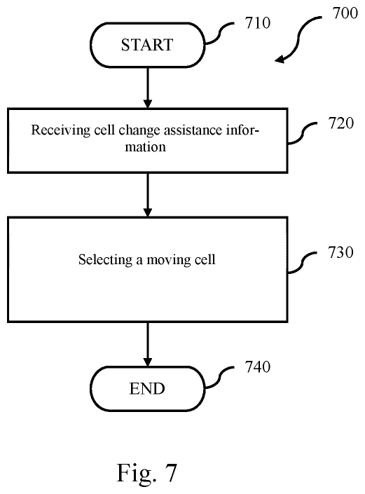

FIG. 7 illustrates a flow chart of a method 700, as performed by a user equipment 120, for preparing cell change of the UE, in a non-terrestrial network, NTN, with a plurality of moving cells served by at least one satellite. The method 700 comprises a step 720 of receiving cell change assistance information by the UE.

The received cell change assistance information is provided by a network element of the NTN. It identifies at least a subset of the plurality of moving cells and is indicative of a geometric layout of at least the subset of the plurality of moving cells.

The method further comprises a step 730 of selecting at least one moving cell as target cell for cell change. The selecting of at least one moving cell from the plurality of moving cells as target cell for cell change is based on the received cell change assistance information.

Moreover, the selecting may be based on information indicative of UE position and/or UE movement. This may be similar to the considerations detailed above with respect to generating cell change assistance information on the basis of UE position and/or UE movement. However, the selecting may be based on information indicative of UE position and/or UE movement even in cases where the generated cell change assistance information has not been generated on the basis of UE position and/or UE movement. For instance, the network element may broadcast generic (i.e., non-individualized) cell change assistance information to multiple or all UEs, while the UE may individualize this information based on its own position and/or movement.

More particularly, in the example illustrated in FIG. 5, both the UE position and the UE movement support selecting cell D as target cell (rather than cell C, for instance). Similarly, satellite movement, cell location and/or cell movement may be taken into account. Finally, received power may be taken as an indication of the distance between the UE and the cell center. Thus, based on the cell change assistance information received at step 720 for at least the subset of moving cells, received power may be taken as a basis for selecting a target cell among those cells indicated by the cell change assistance information. Finally, expected availability time of the cell is an indication of the time in a given cell until the next mobility event. Contrary to received power, expected availability time depends on both the distance between UE and cell border and on the movement of the moving cell. Considering the example of FIG. 5, cells A and cells D are likely to have (roughly) the same estimate for received power for UE 120. However, due to satellite movement, cell D has a considerably longer expected availability time than cell A.

Returning to the description of FIG. 7, step 730 of selecting at least one moving cell as target cell may further be followed by a step of performing cell change, in response to one or more radio-based measurement events. For instance, one or more moving cells are selected such that measurements are performed for the one or more moving cells. In response to the measurements, a cell change is performed to one of the selected one or more moving cells. Alternatively, cell change may be performed in response to one or more conditional handover, CHO, conditions and/or one or more NTN trigger events.

In any case, the cell change is not limited to performing a handover. Alternatively, the cell change may be embodied by a cell re-selection in RRC idle or inactive cells. In such examples, the cell change assistance information may be broadcasted as part of an RRC Release Message. In a further alternative, the cell change may not require to hand-out the previously serving cell. In particular, the target cell may be used as a secondary cell for dual/multi-connectivity.

Furthermore, the received cell change assistance information may be stored for future use. This allows for the UE to learn the cell pattern for a given satellite or NTN. To this end, the method may further comprise updating a database of cell information (which database comprises previously received cell change assistance information) with the presently received cell change assistance information for use after selecting the cell.

Considering the example of FIG. 5 and Table 1, the database of stored cell information may encode the contents and structure of Table 2 below, under the assumption that the UE had previously stored the information for cell J:

TABLE 2
exemplary cell change assistance information

| Index | Cell identifier | Geometry | Parameters for geometry |
|---|---|---|---|
| A | PCI1 | Circular | Coordinates1, Radius1 |
| B | PCI2 | Circular | Coordinates2, Radius2 |
| C | PCI3 | Circular | Coordinates3, Radius3 |
| D | PCI4 | Circular | Coordinates4, Radius4 |
| E | PCI5 | Elliptical | Coordinates5a, Radius5a |
| | | | Coordinates5b, Radius5b |
| F | (empty) | (empty) | (empty) |
| G | (empty) | (empty) | (empty) |
| H | (empty) | (empty) | (empty) |
| I | (empty) | (empty) | (empty) |
| J | PCI10 | Circular | Coordinates10, Radius10 |

In such cases, any future selecting of a target cell may further be based on the stored database of previously received cell change assistance information (along with any presently received cell change assistance information). This allows for the UE to learn the satellite footprint, even if the cell change assistance information transmitted at a given time covers only a partial footprint. Moreover, in some embodiments, the UE may signal to the network elements whether and which cells of the cell layout have already been stored such that the generating and providing of cell change assistance information can be restricted to those portions of the footprint, which are currently unknown to the UE. This allows to further reduce signaling overhead.

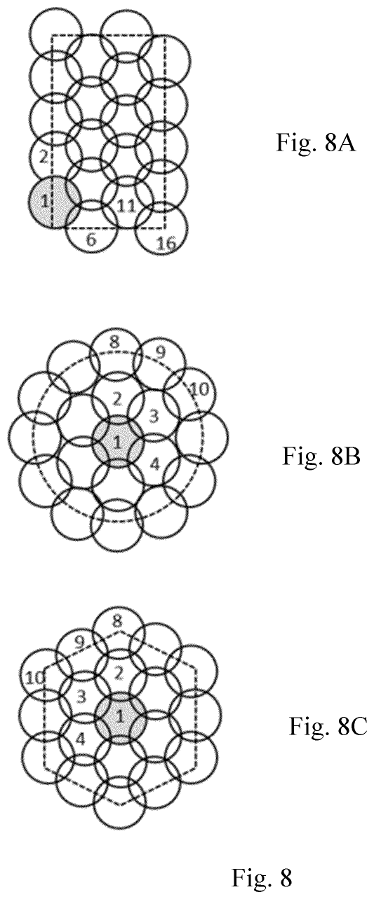

FIG. 8 illustrates various footprint layouts, each with a geometric cell pattern and a respective numbering of cell identifiers within the footprint layout.

In particular, FIG. 8A illustrates a rectangular pattern, characterized in that multiple constituent cells of the rectangular pattern are arranged along multiple straight lines, which run essentially parallel to each other. For instance, in the pattern as depicted in FIG. 8A, cells 1, 2, et seq. are arranged along a first straight line; cells 6 et seq. are arranged along a second straight line (which is parallel to the first straight line); cells 11 et seq. are arranged along a third straight line (which is parallel to the first and second straight lines); and cells 16 et seq. are arranged along a fourth straight line (which is parallel to the first, second and third straight lines).

FIG. 8B illustrates a circular pattern, characterized in that multiple constituent cells of the circular pattern are arranged on concentric circles with increasing radius. For instance, in the pattern as depicted in FIG. 8B, cell 1 is located at the (common) center; cells 2, 3, 4 et seq. are arranged on a first circle, with a first radius and the (common) center; cells 8, 9, 10 et seq. are arranged on a second circle, with a second (larger) radius and the (common) center.

FIG. 8C illustrates a hexagonal pattern, characterized in that multiple constituent cells of the hexagonal pattern are arranged on concentric hexagons with increasing edge lengths. For instance, in the pattern as depicted in FIG. 8C, cell 1 is located at the (common) center; cells 2, 3, 4 et seq. are arranged on a first hexagon, with a first edge length and the (common) center. The first edge length corresponds essentially to the center-to-center distance of two neighboring cells (e.g., cells 2 and 3). Cells 8, 9, 10 et seq. are arranged on a second hexagon, with a second (larger) edge length and the (common) center. The first edge length corresponds essentially to the center-to-center distance of two non-neighboring cells (e.g., cells 8 and 10).

Without loss of generality, further geometric patterns are conceivable. The definition of pre-defined footprint layouts allows for signaling merely an indication of which pre-defined footprint layout is applicable and potentially any further parameters for further detailing the specific configuration. For instance, considering the rectangular example of FIG. 8A, an additional parameter to be signaled may indicate the identifier (e.g., PCI or GCID) of the first cell, i.e., cell 1 at the bottom left. Alternatively, the respective identifier for the first cell of each column (i.e., of cells 1, 6, 11 and 16) may be indicated.

Other parameters for further detailing the specific configuration include the beam shape and size. For instance, the beam shape may be indicated as being circular (with radius R or with diameter D) or as being elliptical (with two radii or two diameters). Furthermore, the beam spacing may be indicated (e.g., as a number of arc degrees on Earth). Additionally, or alternatively, for each footprint pattern, a numbering scheme for cell identifiers within that pre-defined footprint layout (e.g. clock-wise or counter-clock-wise, column-wise or row-wise; starting at bottom left, bottom right, top left, top right, center etc.).

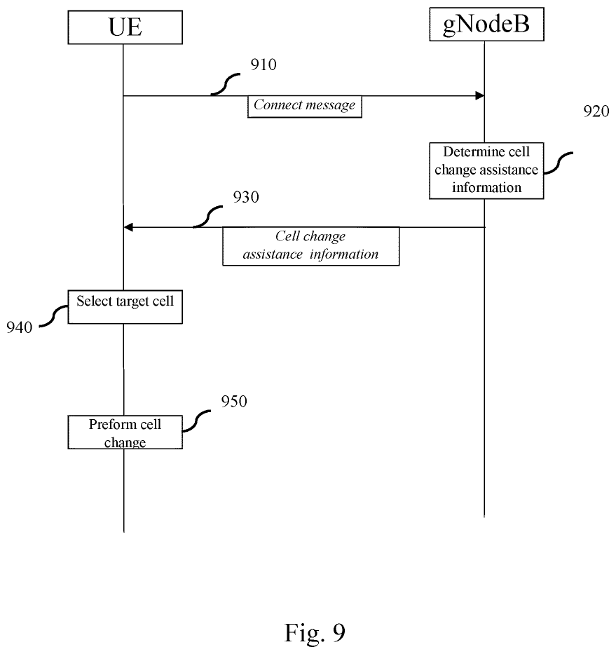

FIG. 9 illustrates an exemplary communication between a user equipment and a network element (gNodeB in the illustrated example).

The UE connects to a cell of the non-terrestrial network (step 910). In response, the network determines cell change assistance information (e.g., a partial footprint of the cell layout; the preferred neighboring cells for the respective UE; or an indication of the pre-defined footprint layout to be signaled). Subsequently, at step 930, this information is signaled to the UE. This signalization can be implicit, e.g., via pre-defined cell layout and PCI allocation sequence as described above, or explicit, e.g., via RRC message.

In general, the routines executed to implement the embodiments, whether implemented as part of an operating system or a specific application, component, program, object, module or sequence of instructions, or even a subset thereof, may be referred to herein as “computer program code” or simply “program code”. Program code typically comprises com-puter-readable instructions that are resident at various times in various memory and storage devices in a computer and that, when read and executed by one or more processors in a com-puter, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the disclosure. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While a description of various embodiments has illustrated all of the inventions and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative UE and method, and illustrative examples shown and described. Accordingly, departures may be made from such details without departing from the spirit or scope of the applicant's general inventive concept.

1. A method for cell change assistance in a non-terrestrial network, NTN, with a plurality of moving cells served by at least one satellite, the method comprising:
providing, by a network element of the NTN to a user equipment, UE, cell change assistance information for selecting at least one moving cell of the plurality of moving cells, the cell change assistance information identifying at least a subset of the plurality of moving cells and being indicative of a geometric layout of at least the subset of the plurality of moving cells.

2. The method according to claim 1, further comprising: generating, by the network element, the cell change assistance information, wherein the generating is based on information indicative of one or more of the following: a serving cell for the UE; a position of the UE; a movement of the UE; a movement of the satellite.

3. (canceled)

4. A method for preparing cell change of a user equipment, UE, in a non-terrestrial network, NTN, with a plurality of moving cells served by at least one satellite, the method comprising:
receiving, by the UE, cell change assistance information provided by a network element of the NTN for selecting a cell for cell change, the cell change assistance information identifying at least a subset of the plurality of moving cells and being indicative of a geometric layout of at least the subset of the plurality of moving cells; and
selecting, by the UE, at least one moving cell from the plurality of moving cells as target cell for cell change, based on the received cell change assistance information.

5. The method according to claim 4, wherein the method further comprises:
updating a database of cell information, the database comprising previously received cell change assistance information, with the presently received cell change assistance information for use after selecting the cell.

6. The method according to claim 5, wherein the selecting is further based on the stored database of previously received cell change assistance information and/or presently received cell change assistance information.

7. The method according to claim 4, wherein the selecting is further based on information indicative of one or more of the following: a position of the UE; a movement of the UE; a movement of the satellite; a location of the cell; a movement of the cell; a received power of the cell at the UE; an expected availability time of the cell coverage at the UE position.

8. The method according to claim 4, further comprising: performing cell change, in response to one or more of the following: one or more radio-based measurement events; one or more conditional handover, CHO, conditions; one or more NTN trigger events.

9. The method according to claim 1, wherein the cell change assistance information is further indicative of the movement of the plurality of cells.

10. The method according to claim 1, wherein the subset of moving cells indicated by the cell change assistance information constitute less than a full footprint of cells served by the satellite.

11. The method according to claim 1, wherein the cell change assistance information is indicative of one of a plurality of pre-defined footprint layouts, wherein each of the plurality of pre-defined footprint layouts is characterized by a geometric cell pattern.

12. (canceled)

13. The method according to claim 11, wherein the cell change assistance information is further indicative of a numbering of cell identifiers within the indicated one of the plurality of pre-defined footprint layouts.

14.-20. (canceled)

21. A user equipment, UE, configured for preparing cell change in a non-terrestrial network, NTN, with a plurality of moving cells served by at least one satellite, wherein the UE comprises at least one processor; and at least one memory storing instructions that, when executed by the at least one processor cause the UE to:
receive cell change assistance information provided by a network element of the NTN for selecting a cell for cell change, the cell change assistance information identifying at least a subset of the plurality of moving cells and being indicative of a geometric layout of at least the subset of the plurality of moving cells; and
select at least one moving cell from the plurality of moving cells as target cell for cell change, based on the received cell change assistance information.

22. The user equipment according to claim 21, being further caused to:
update a database of cell information, the database comprising previously received cell change assistance information, with the presently received cell change assistance information for use after selecting the cell.

23. The user equipment according to claim 22, being further caused to select at least one moving cell further based on the stored database of previously received cell change assistance information and/or presently received cell change assistance information.

24. The user equipment according to claim 21, wherein the selecting is further based on information indicative of one or more of the following: a position of the UE; a movement of the UE; a movement of the satellite; a location of the cell; a movement of the cell; a received power of the cell at the UE; an expected availability time of the cell coverage at the UE position.

25. The user equipment according to claim 21, being further caused to: perform cell change, in response to one or more of the following: one or more radio-based measurement events; one or more conditional handover, CHO, conditions; one or more NTN trigger events.

25-35. (canceled)
